(19) United States
(12) Patent Application Publication
(10) Pub. No.: US 2006/0270463 A1
(43) Pub. Date: Nov. 30, 2006

(54) VENUE-CONTROLLED DISABLING OF CAPABILITIES OF MOBILE COMMUNICATION DEVICES

(76) Inventor: Max Copperman, Santa Cruz, CA (US)

Correspondence Address: MAX COPPERMAN, 1753 KING STREET, SANTA CRUZ, CA, 95060, US

(21) Appl. No.: 10/908,790

(22) Filed: May 26, 2005

(51) Int. Cl. H04B 1/38; H04M 1/00; H04Q 7/38

(52) U.S. Cl. 455/567; 455/550.1; 455/414.1

(57) ABSTRACT

This document discusses, among other things, systems, devices, and methods for venue-controlled disabling of an audible alert or other capability of a mobile communication device. In one example, users entering a venue receive a signal turning their cell phones off or switching them from ring to vibrate. In a further example, the phones are restored to a previous state when audible communication using the phone is no longer undesirable. In a further example, the venue includes a telephony base station to which phones are registered when present at the venue. The telephony base station intercepts calls to or from the mobile phones at the venue to inhibit calls to or from the mobile phones, such as when audible communication using the phone is undesirable.

### TECHNICAL FIELD

This patent document pertains generally to telecommunications, and more particularly, but not by way of limitation, to venue-controlled disabling of one or more capabilities of a cellular telephone or other mobile communication devices.

### BACKGROUND

Cell phones are ubiquitous and handy. To be useful, a cell phone must alert its user when there is an incoming call; phones ring for that purpose, and many phones can be set to vibrate substantially inaudibly instead of producing an audible ring.

Ringing cell phones generate a disturbance in concerts, movies, church, meetings, and other circumstances in which quiet is desired. It's common for the person introducing a program to ask the audience members to turn off their cell phones—with moderate success; it is not uncommon for one or more audience members to neglect to turn off their phone, and for one of these phones to ring during the program. This not only disturbs the rest of the audience, but also embarrasses the phone's owner.

Moreover, any cell phone use (not merely the audible ring) is problematic in circumstances where the cell phone's use of the radio channels may interfere with more important radio communication, such as airplane communications, for example, during takeoff and landing.

However, it is also true that it may be very important for someone to receive a call even though they are engaged in an activity which would be disturbed by the phone's ring.

### SUMMARY

The present inventor has recognized a need for a venue, such as a theater, concert hall, or chapel, to be able to directly turn off the ringing of cell phones-without requiring any action on the part of each phone's owner. Moreover, as discussed above, an aircraft is a venue with an even more compelling need to be able to directly turn off a cell phone than a concert hall.

This patent application describes, among other things, systems, devices, and methods that enable a venue to send a signal to each phone present at the venue, such that the phones, upon receiving the signal, turn themselves off in response. Because, as discussed above, it may be very important for someone to receive a call even though they are engaged in an activity which would be disturbed by the phone's ring, the present patent application also describes systems, devices, and methods that enable a venue to send a signal to each phone present at the venue, such that the phones, in response to receiving the signal, switch from generating an audible ring to instead generating a substantially inaudible alert, such as a vibration.

In one example, users entering a venue receive a signal turning their cell phones off or switching them from ring to vibrate. In a further example, the phones are restored to a previous state when audible communication using the phone is no longer undesirable. In a further example, the venue includes a telephony base station to which phones are registered when present at the venue. The telephony base station intercepts calls to or from the mobile phones at the venue to inhibit calls to or from the mobile phones, such as when audible communication using the phone is undesirable.

In another example, a machine-assisted method includes communicating a signal between a remote device and at least one mobile communication device when the mobile communication device is located in association with a venue hosting an occasion when audible usage of the mobile communication device is undesirable. An audible alert of the mobile communication device is automatically disabled in response to the signal. The method may include numerous variations. In one variation, the communicating the signal includes sending a venue-controlled signal from the remote device to the mobile communication device. In another variation, disabling the audible alert includes turning off the mobile communication device in response to the signal. In another variation, the disabling the audible alert includes switching the mobile communication device from an audible alert mode to a substantially inaudible alert mode in response to the signal. In another variation, the switching the mobile communication device from an audible alert mode to a substantially inaudible alert mode in response to the signal includes switching, in response to the signal, the mobile communication device from an audible ring mode to a substantially inaudible vibration mode of responding to an incoming call. In another variation, the disabling the audible alert includes disabling, in response to the signal, an audible alert of all mobile communication devices located in association with the venue in response to the signal. In another variation, the disabling the audible alert includes first checking whether a particular mobile communication device is registered for a disabling service before performing the disabling. In another variation, the method includes billing an additional charge to a user of the mobile communication device that is registered for the disabling service. In another variation, the communicating a signal between a remote device and at least one mobile communication device comprises communicating the signal with a remote device located in association with an entry of the venue. In another variation, the communicating a signal between a remote device and at least one mobile communication device comprises communicating the signal with a remote device capable of broadcasting the signal over an entire desired area of the venue. In another variation, the communicating a signal between a remote device and at least one mobile communication device comprises communicating the signal with a set of remote devices that, together, are capable of broadcasting the signal over an entire desired area of the venue, and which are capable of avoiding broadcasting the signal outside the desired area of the venue. In another variation, the communicating a signal between a remote device and at least one mobile communication device includes communicating a signal between a radio frequency (RF) remote device and the at least one mobile communication device. In another variation, the communicating a signal between a remote device and at least one mobile communication device includes communicating a signal between the RF remote device and a first RF receiver at the mobile communication device; the first RF receiver at the mobile communication device is separate from a second RF receiver at the mobile communication device that is used to communicate audio information to the mobile communication device. In another variation, the communicating a signal between a remote device and at least one mobile communication device includes communicating a signal between the RF remote device and an RF receiver at the mobile communication device that is also used to communicate audio information to the mobile communication device. In another variation, the communicating a signal between a remote device and at least one mobile communication device includes communicating a signal between a cell phone telephony base station as the remote device and the at least one mobile communication device. In another variation, the communicating a signal between a remote device and at least one mobile communication device includes using at least one of infrared communication, sonic communication, magnetic or electro-magnetic, or chemical communication. In another variation, the method includes saving information about a state of at least one switch of the mobile communication device before the disabling the audible alert, modifying the state of the at least one switch in conjunction with the disabling the audible alert, and restoring the state of the at least one switch of the mobile communication device after the disabling the audible alert. In another variation, the restoring the state of the at least one switch of the mobile communication device is carried out in response to communicating a second signal between the remote device and the mobile communication device. In another variation, the communicating a signal between a remote device and at least one mobile communication device includes communicating information about a time at which the restoring the state of the at least one switch is to be carried out. In another variation, the communicating the signal between the remote device and at least one mobile communication device includes registering the mobile communication device to a base station associated with the venue, and the automatically disabling the audible alert of the mobile communication device includes using the base station to intercept a call to or from the mobile communication device in response to the registering the mobile communication device to the base station associated with the venue. In another variation, the automatically disabling an audible alert of the mobile communication device comprises inhibiting a call to the mobile communication device.

In another example, a system includes a mobile communication device, where the mobile communication device includes a speaker to provide an audible alert and a communication transceiver to communicate a signal with a remote device to automatically disable the audible alert in response to the signal. In one variation, the system includes a switch to disable the audible alert; the switch controls at least one of a power-on status and a ring/vibrate status of the mobile communication device. In another variation, the mobile communication device includes a memory location to store information indicating whether the mobile communication device is registered for a service to automatically disable the audible alert; the mobile communication device includes a controller that checks the memory location to determine whether the mobile communication device is registered for the service as a precondition of the automatically disabling the audible alert. In another variation, the remote communication device has access to information indicating whether the mobile communication device is registered for a service to automatically disable the audible alert; the remote communication device includes a controller that checks whether the mobile communication device is registered for the service as a precondition of the automatically disabling the audible alert. In another variation, the mobile communication device includes at least one memory location to save information about a state of at least one switch of the mobile communication device before the disabling the audible alert, and the mobile communication device includes a controller that restores the state of at least one switch of the mobile communication device using the saved information about the state of the at least one switch of the mobile communication device. In another variation, the system further includes the remote device. In another variation, the remote device includes an RF transmitter providing the signal to automatically disable the audible alert of the mobile communication device. In another variation, the remote device includes a telephony base station associated with a venue, the telephony base station providing the signal to automatically disable the audible alert of the mobile communication device.

In another example, a system includes a remote communication device, for location at a venue hosting an occasion when audible usage of a mobile communication device is undesirable, the remote communication device permitting communication of a signal with at least one mobile communication device at the venue to automatically disable an audible alert of the mobile communication device. In one variation, the remote communication device includes a telephony base station for the venue to intercept calls to or from all mobile communication devices located at a designated area of the venue to disable the audible alert of the mobile communication devices.

This summary is intended to provide an overview of the subject matter of the present patent application. It is not intended to provide an exclusive or exhaustive explanation of the invention. The detailed description is included to provide further information about the subject matter of the present patent application.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 shows an example of a cell phone, a base station, and a venue-controlled signal source for turning off the cell phone.

FIG. 2 shows another example of a cell phone, a base station, and a venue-controlled signal source for switching a cell phone from a ring mode to a vibrate mode.

FIG. 3 shows an example of a cell phone, a base station, and a venue-controlled signal source for turning off the cell phone or switching it from a ring mode to a vibrate mode.

FIG. 4 shows an example of a concert hall or other venue including several doorways with a signal emitter located at each doorway or selected doorways.

FIGS. 5A, 5B, and 5C show an example of a sequence of values in the phone's memory and the states of switches as a person carrying the phone enters, is inside, and leaves a concert hall through a doorway including a signal emitter.

FIGS. 6A and 6B respectively show examples of interior and exterior views of a concert hall with a higher power signal emitter that broadcasts a signal across the entire hall.

FIG. 7 shows an interior view of a concert hall with numerous low power signal emitters that each broadcast a signal to an area of the hall.

FIG. 8 shows a base station or similar equipment associated with a concert hall; the range of the base station equipment is typically approximately the area of the concert hall.

FIG. 9 shows a cell map of a network at least one concert hall; FIG. 9 also shows a partial Home Location Register entry for this network.

FIG. 10 shows a logic flow diagram for the new logic used for one example of the present techniques.

FIG. 11 shows a logic flow diagram for the new logic used for another example of the present techniques.

FIG. 12 shows a logic flow diagram for the new logic used for yet another example of the present techniques.

FIG. 13 shows a logic flow diagram for the new logic used for one example of the present techniques; this example can be regarded as both venue-controlled and provider-controlled.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, a cell phone is used as an illustrative example, but is not intended as a limitation. The present techniques also apply to a pager, Blackberry, personal digital assistant (PDA), or other handheld mobile communication device. Similarly, as an example but not a limitation, the term “ring” is used to designate any sort of audible alert used by a speaker or the like to tell the device's user of an incoming communication (a phone call, page, e-mail, appointment reminder, etc.), and the term “call” is used to designate any such incoming communication. And again as an example but not a limitation, the term “concert hall” is used to designate any area or venue in which there is benefit in turning off devices or their rings-any dedicated quiet zone. For example, the present techniques also apply to chapels, theatres, aircraft, meeting rooms, laboratories, any building or vehicle in which mobile device communication would be disruptive to electronic communication taking place in the building or vehicle, or any building or vehicle in which mobile device communication would disruptive to the social activity taking place in the building or vehicle.

A cell phone has an on/off switch that can be set in the on or off position manually. It may have a ring/vibrate switch that can be manually set to the ring position, in which case the cell phone will ring when a call comes in, or to the vibrate position, in which case the cell phone will not ring but will vibrate when a call comes in. The present document describes, among other things, various ways that a concert hall or other venue can send a signal to a phone, and the phone can receive and recognize the signal, and can respond to the signal by changing the setting of the on/off or ring/vibrate switch.

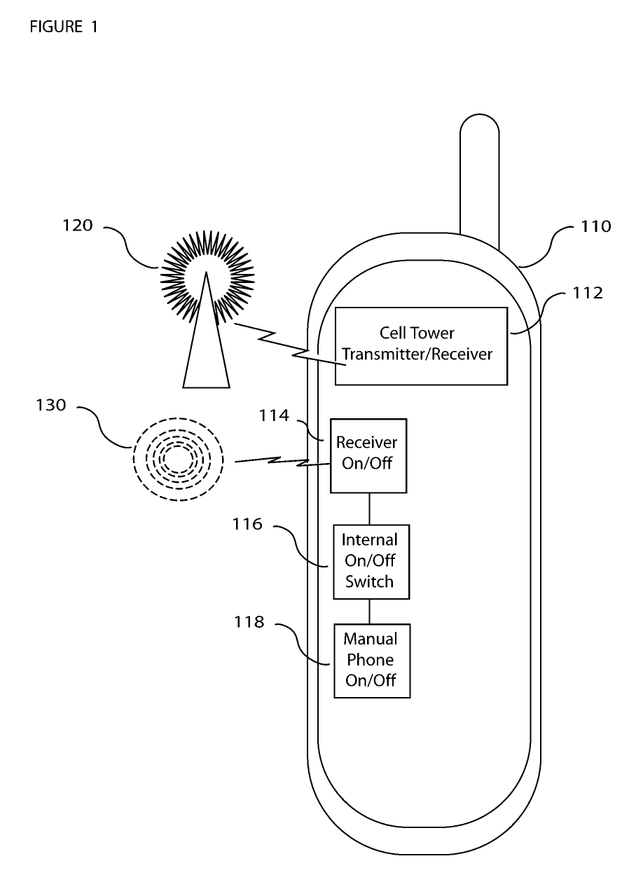

FIG. 1 shows an example of a cell phone 110, a base station 120, and a venue-controlled signal source 130. In this example, the phone 110 has the standard reception and transmission equipment 112 for communicating with the base station 120, and an external control 118 used for manually turning the phone 110 on and off. External control 118 is connected to internal on/off switch 116.

In this example, the phone 110 also has an additional receiver 114 that receives one or more signals from signal source 130 and that is connected to on/off switch 116. The phone 110 can be turned on or off either with the external control 118 or by receiving a signal from venue-controlled source 130. Although the example of FIG. 1 illustrates an additional receiver 114, in an alternate example, the receiver 114 is the same transceiver 112 for communicating with the base station 120, however, the transceiver 112 is configured to also recognize a command from venue-controlled source 130 to turn off phone 110.

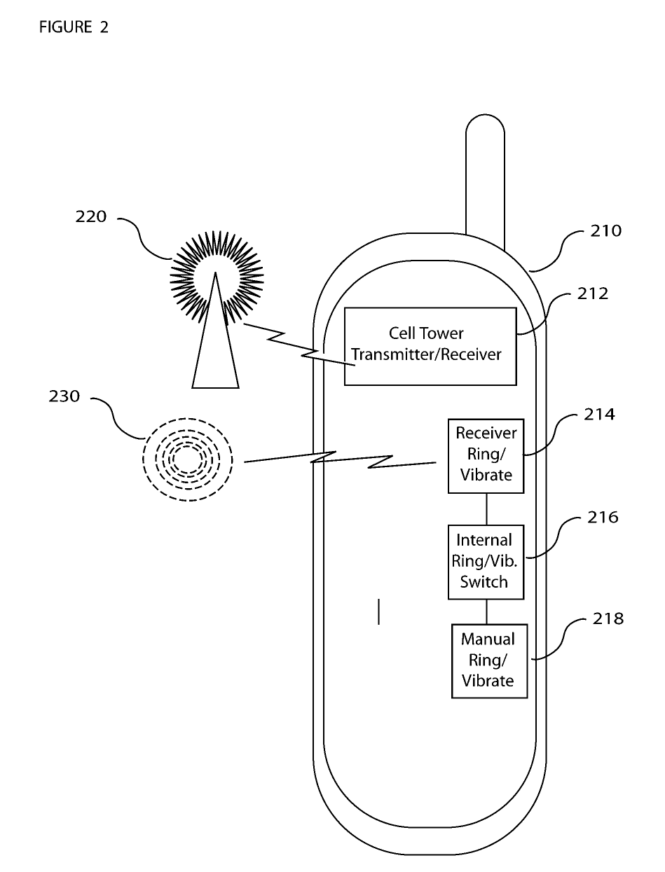

FIG. 2 shows another example of a cell phone 210, a base station 220, and a venue-controlled signal source 230. In this example, the phone 210 includes the standard reception and transmission equipment, such as transceiver 212, for communicating with the base station 220. The phone 210 also includes an external control 218 for manually turning the phone 210 from an audible ring mode to a substantially inaudible vibrate mode, or vice-versa. External control 218 is connected to internal ring/vibrate toggle 216. In one example, the phone 210 also has an additional receiver 214 that receives signals from the venue-controlled signal source 230 and that is connected to ring/vibrate toggle switch 216. In this example, the phone 210 can be turned from ring mode to vibrate mode or vice-versa either with the external control 218 or in response to a signal received from the venue-controlled signal source 230. Although the example of FIG. 2 illustrates an additional receiver 214, in an alternate example, the receiver 214 is the same transceiver 212 for communicating with the base station 220, however, the transceiver 212 is configured to also recognize a command from venue-controlled source 230 to switch an incoming communication alert mechanism of the phone 210 from an audible ring to a substantially inaudible vibration or the like.

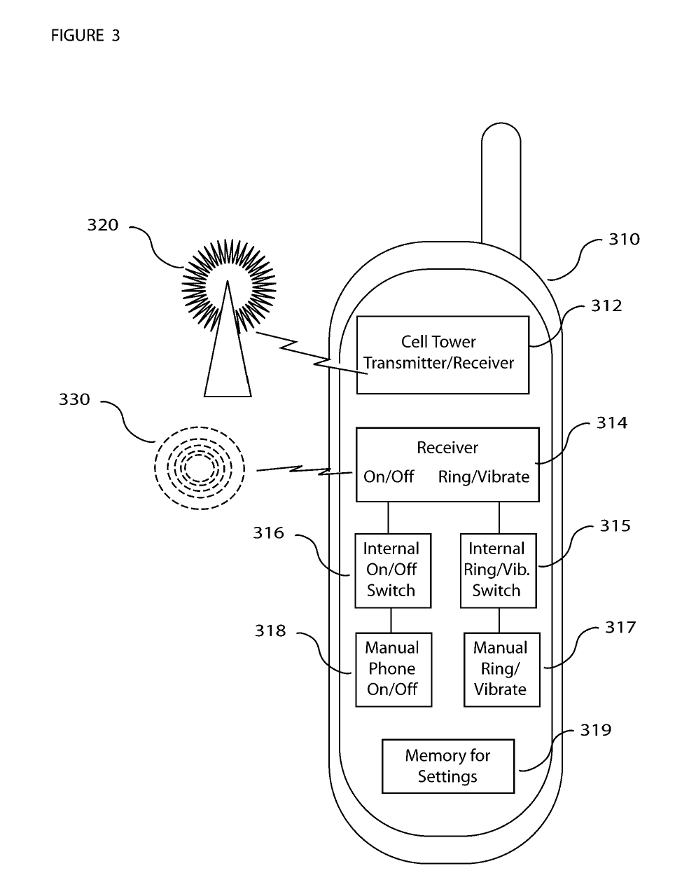

FIG. 3 shows an example of a cell phone 310, a base station 320, and an venue-controlled signal source 330. In this example, the phone 310 includes the standard reception and transmission equipment, such as the transceiver 312, for communicating with the base station 320. The phone 310 also includes an external control 318 used for manually turning the phone 310 on and off, and external control 317 used for manually switching the phone 310 from ring to vibrate or vice-versa. External control 318 is connected to internal on/off switch 316. External control 317 is connected to internal ring/vibrate toggle 315. In one example, the phone 310 also has an additional receiver 314 that receives one or more signals from signal source 330 and that is connected to both on/off switch 316 and ring/vibrate switch 315. The phone 310 can be turned on or off either with the external control 318 or by receiving one signal from source 330. The phone 310 can be turned from ring mode to vibrate mode, or vice-versa, either using the external control 315 or by receiving another signal from venue-controlled signal source 330. Finally, in one example, the phone 310 in FIG. 3 includes internal memory 319 to store the state of the internal On/Off and Ring/Vibrate switches at the time that the audible alert disabling or inhibiting signal from the venue-controlled source 330 is received by the phone 310. Although the example of FIG. 3 illustrates an additional receiver 314, in an alternate example, the receiver 314 is the same transceiver 312 for communicating with the base station 320, however, the transceiver 312 is configured to also recognize a first command from venue-controlled source 330 to turn off the phone 310 or a second command from venue-controlled source 330 to switch an incoming communication alert mechanism of the phone 310 from an audible ring to a substantially inaudible vibration or the like.

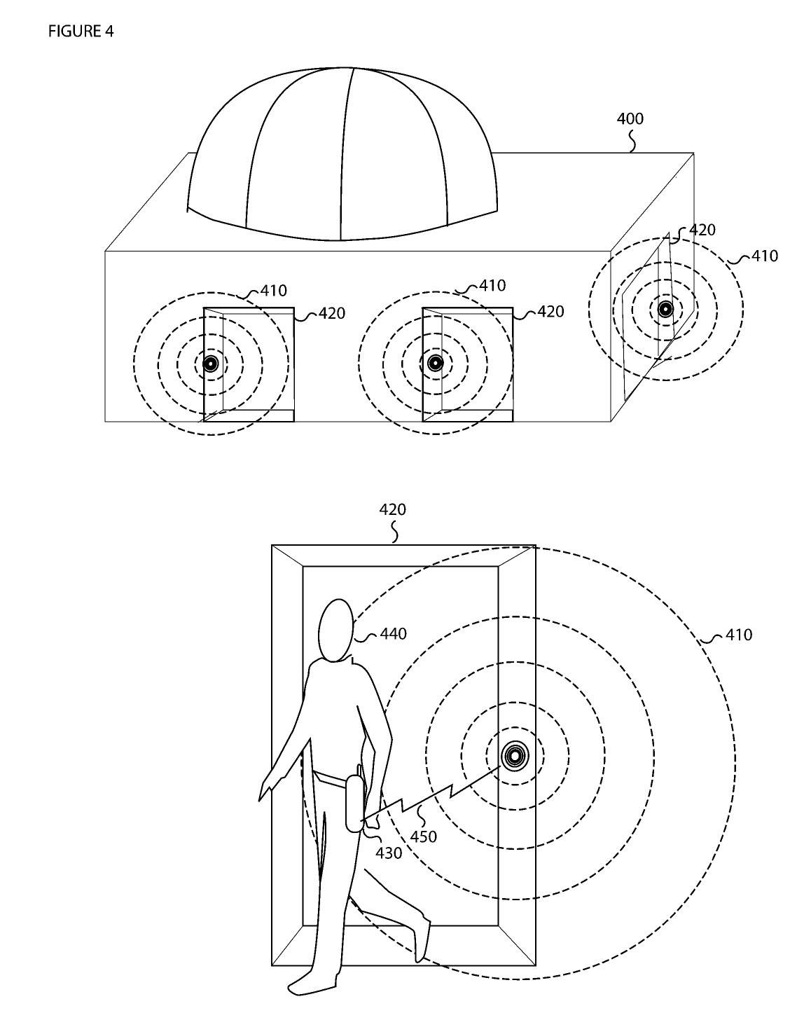

FIG. 4 shows an example of a concert hall 400 or other venue including several doorways 420 with a signal emitter 410 embedded in each doorway 420. An expanded view of the doorway 420 shows a person 440 walking through the doorway 420 with a cell phone 430, which is receiving a signal 450 from the signal emitter 410.

As shown in FIG. 4, a concert hall 400 can send a signal via a sending device 410 stationed or housed in a doorway 420 of the hall 400. Each doorway 420 can house such a signal emitter 410, or select doorways 420 can house such a signal emitter device 410. This is conceptually similar to the situation in a typical retail-clothing outlet. If a shopper attempts to leave with an article that has not been paid for, when the shopper exits through the doorway, an alarm is triggered.

In the retail-clothing outlet, the article of clothing contains an EAS (Electronic Article Surveillance) tag which is removed when the article is paid for. The tag emits a low power radio signal. An EAS tower (a receiver) is stationed in or near the doorway, and can be built into the doorway to be unobtrusive. If a shopper leaves with an item that has an EAS tag, the radio signal emitted by the tag is received by the tower, which triggers the alarm.

In the example of FIG. 4, the retail store situation is reversed. As shown in FIG. 4, a low power radio signal emitter 410 is stationed in or near, or embedded in, a concert hall doorway 420. A receiver 114, 214, 314 is built into the cell phone 430. When the phone 430 passes through a doorway 420 in the pocket, handbag, briefcase, or hand of its owner 440, the phone 430 receives the signal 450. In one example, the phone 430 includes a receiver 114 that is connected to either a hardware or software switch 116 that turns the phone 430 off, as described above with respect to FIG. 1. In another example, the phone 430 includes a receiver 214 that is connected to a switch 216 that turns the phone 430 from a ring mode to a vibrate mode, as described above with respect to FIG. 2. In another example, the phone 430 includes a receiver 314, the receiver is connected to two switches 316 and 315 such that upon receiving a signal at one frequency or coding it turns the phone 430 off and upon receiving a signal at another frequency or coding it turns the phone 430 from a ring mode to a vibrate mode.

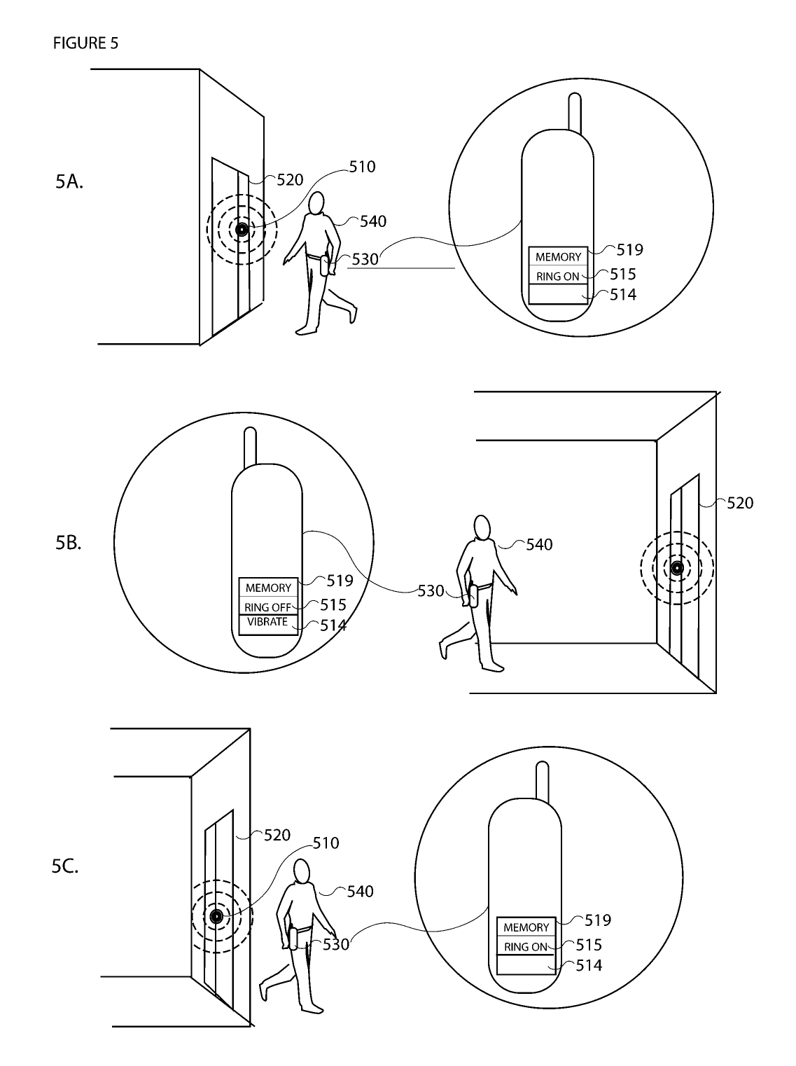

FIGS. 5A, 5B, and 5C show an example of a sequence of values in the phone's memory 519 and the states of switches 514, 515 as a person 540 carrying the phone 530 enters, is inside, and leaves a concert hall through a doorway 520 including a signal emitter 510.

People may forget to turn their phones back on when they leave the concert hall, and this could be a cause of irritation that affects the acceptance of the venue-controlled technology. To address this problem, in one example, the phone is built so that upon leaving the hall, the settings of its switches (e.g., on/off switch 116, 316; ring/vibrate switch 216, 315) are returned to whatever they were upon entering the hall.

In one example, this is accomplished by storing in the phone's persistent memory 319 the settings of the phone's switches at the time when the phone first receives the venue-controlled signal (before the venue-controlled signal changes those settings) when the person walks through the doorway into the concert hall. The next time the phone receives the venue-controlled signal, the phone's switches are restored to such stored settings representative of the phone's state before the first venue-controlled signal was received.

FIGS. 5A, 5B, and 5C illustrate an example of such operation. In this example, initially the phone memory 519 is clear, as shown in FIG. 5A. When a person 540 enters a concert hall doorway 520 and the phone 530 first receives a venue-controlled signal from signal emitter 510, the then-existing settings of the switches 514, 515 are stored in the phone's memory 519. Then, the state of one or more of the switches 514, 515 is changed according to the venue-controlled signal that has been received (e.g., either the phone 530 is turned off or it is switched from ring mode to vibrate mode), as shown in FIG. 5B. When the person 540 leaves the hall, going through the doorway 520 again so that the phone receives the venue-controlled signal again, the switches are changed back to the settings stored in the phone's memory 319 and the memory 319 is then cleared, as shown in FIG. 5C.

In another technique for restoring the pre-venue settings of the phone 530 is for the initial venue-controlled signal received by the phone 530 when the person enters the venue to include time information to establish a quiet time period over which the audible alert suppression is valid. After the quiet time period expires, the pre-venue settings of the phone 530 are automatically restored by the phone 530. The time information provided by the venue-controlled signal can be either a time duration or an specified time-of-day for restoring the pre-venue state of the phone's switches. Most phones include clock and date functionality that can adapted for use with logic returning the switches to the pre-venue states. Similarly, the time information could be used to establish the actual start time of the quiet period, thereby enabling users to continue to use their cell phones, for example, while inside the venue, but before a performance begins.

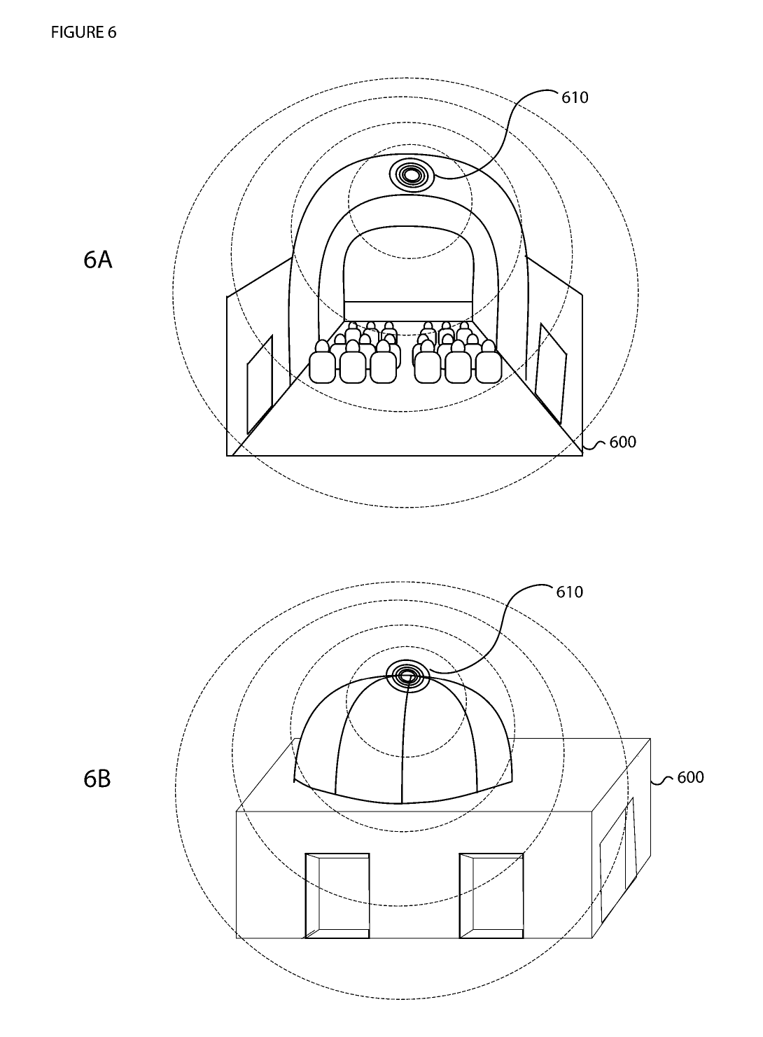

FIGS. 6A and 6B respectively show examples of interior and exterior views of a concert hall 600 with a higher power signal emitter 610 that broadcasts a signal across the entire hall 600. An alternative to embedding low power signal emitters 410, 510 in each entryway (or select entryways) is to have one higher power signal emitter 610 that broadcasts the signal across the entire concert hall 620. A signal could be broadcast at the beginning of the performance, allowing phones to ring during the period after entering the concert hall and before the performance begins. A second signal could be broadcast at the end of the performance, returning the phones to their original settings. One potential risk is that a broadcast signal is not limited to the concert hall performance space, but will be received by any phone within signal range, which could extend outside the concert hall.

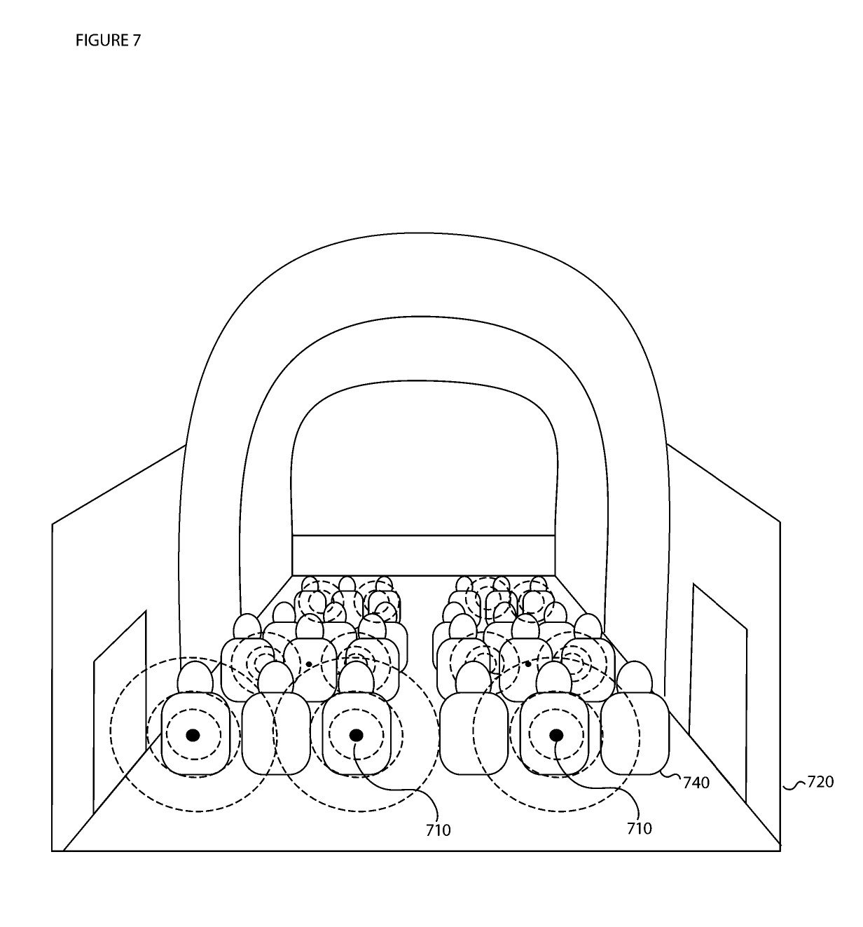

FIG. 7 shows an interior view of a concert hall 700 with numerous low power signal emitters 710 that broadcast a signal to a small area of the hall 700. The example of FIG. 7 obtains an advantage of the broadcast mechanism of FIG. 6, in that the example of FIG. 7 can also control the timing when the phones receive the venue-controlled signal, as opposed to being tied to the entry into the concert hall 700. However, because low power signal emitters 710 are used in FIG. 7, this example does not risk affecting phones outside the hall 700. As shown in the example of FIG. 7, numerous low power transmitters 710 can be stationed throughout the hall 700. Such low power transmitters are positioned such that each person 740 is within range of at least one of the low power transmitters 710.

Cell phones, of course, already have radio receivers, to receive the signals that carry the voice and control data for cell telephony. In one embodiment, the frequency of the venue-controlled signal described herein is in a different range from those dedicated to cell telephony, such that the signals used for different purposes do not interfere with each other.

A radio frequency is a common, efficient, and inexpensive signaling mechanism, but of course any venue-controlled signaling mechanism could be used, with attendant advantages and disadvantages. For example, rather than a radio frequency venue-controlled signal, an infrared venue-controlled signal could be generated by the venue-controlled signal emitter and received by the phone. However, an infrared venue-controlled signal typically requires line-of-sight; phones in pockets, handbags, and briefcases would not be affected. In another example, a magnetic field could be generated by the signal emitter and received by the phone. In another example, the venue-controlled signal could use a sound generated by the venue-controlled signal emitter and received by the phone; the sound need not be in the range of human hearing. In another example the venue-controlled signal could use a chemical compound emitted by the venue-controlled signal emitter and triggering receptors in the phone; this signalling mechanism is not currently cost-effective but advances may make it so in the future.

The examples described so far have emphasized installing specialized signal emitters into concert halls, and installing specialized signal receivers into cell phones. Other examples, however use an existing cell phone receiver to receive a venue-controlled signal, thereby putting the specialization into the cell phone control system. As noted above, cell phones have radio receivers, to receive the signals that carry the voice and control data for cell telephony. An alternative to installing a specialized receiver in the phones and using a frequency outside of the range of those dedicated to cell telephony is to use the equipment already in the phones and use the telephony control system to set and reset these switches. It is well known in the art how to send an appropriately coded signal or series of signals from a cell telephony base station to a cell phone in order to control the cell phone—that is how the transfer of frequencies (channels) for a call works, as well as the control of power used by the cell phone in transmission.

Like the previous examples, a modification of current phones is needed to make the on/off and ring/vibrate switches able to be controlled internally, such as by actuation using a venue-controlled signal. Unlike the emphasis of the previous examples, no new receiver need be installed in the cell phones. Instead, cell telephony control signals are extended to control this new cell phone behavior. Two implementations are described below.

In one example, a channel in the downlink spectrum of the mobile telephony network is reserved for the purpose of setting cell phones to vibrate. Upon receiving a signal on that channel, the phone will set itself to vibrate. In this embodiment, any equipment capable of sending a signal in the proper range can be used by a concert hall to generate a venue-controlled signal in a similar manner to that described above with respect to signal emitters 410, 510, 610, 710.

In another example, it isn't merely receiving a signal in a certain frequency range that triggers the phone to set itself to vibrate. Rather, a first control command is defined and transmitted as data carried on one of the control channels. This control command is defined to be compatible with the other control commands transmitted from a base station to a phone (such as a command to change frequencies, or to increase transmission power, a call waiting command, etc.). A second control command is defined; when transmitted as the venue-controlled signal, this second control command resets the phones to their previous settings, as described above.

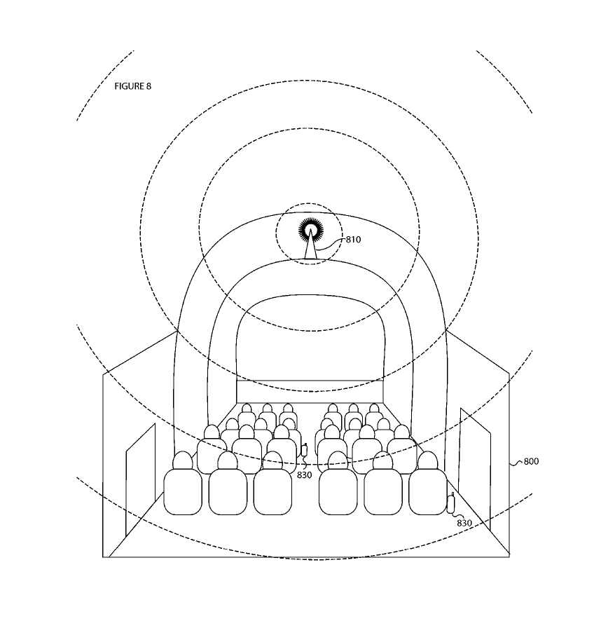

FIG. 8 shows a base station or similar equipment 810 associated with a concert hall 800. In this example, the range of the base station equipment 810 is approximately the area of the concert hall 800, giving it the capability of handling calls to and from any phone 830 in the hall 800. In one example, a (presumably small) fully operational base station 810 is set up in the concert hall 800, with the phones 830 within the concert hall 800 communicating with this venue-associated base station 810. Such phones 830 within the concert hall 800 are registered as under control of the venue's base station 810 in the Location Registers of the cell phone network.

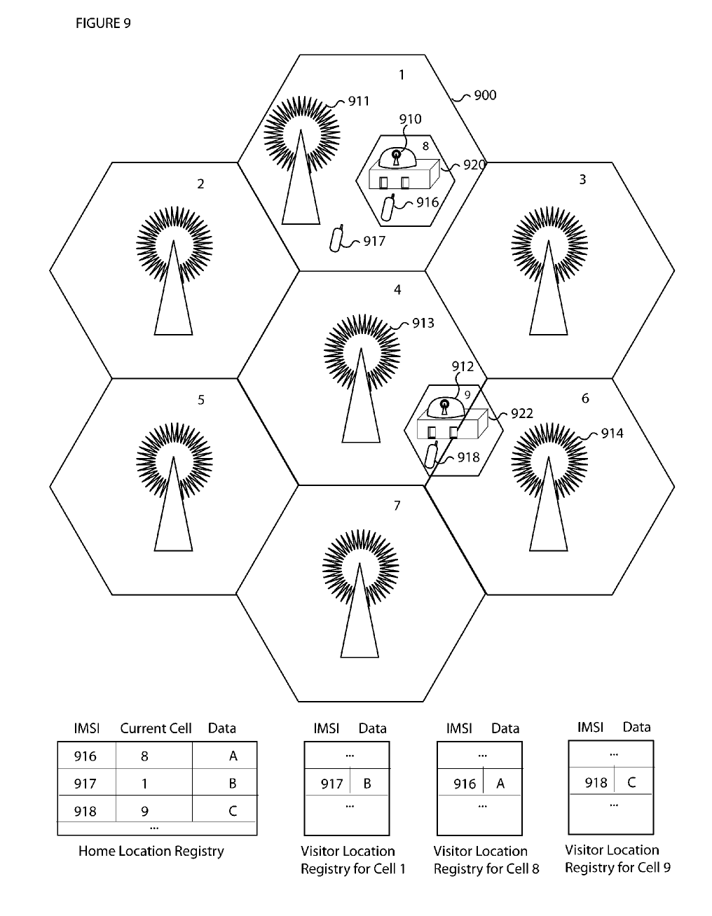

FIG. 9 shows a cell map 900 with concert hall 920 containing its own base station 910 being entirely contained the cell otherwise managed by base station 911, and concert hall 922 containing base station 912 on the border between the cell otherwise managed by base station 913 and the cell otherwise managed by base station 914. The network Home Location Register shows an example of the current cell locations for phones 916, 917, and 918 and the Visitor Location Registries for selected cells show the phones in each cell.

As shown in the example of FIG. 9, a concert hall 920, and hence its base station 910, is likely to be completely contained within the range of another base station 911. For example, network cell 9 is contained in network cell 1. Base stations communicate with each other as phones move from cell to cell, passing call control from one cell to the next as the signal from the phone becomes weaker in one and stronger in the next. In this instance, the venue's base station 910 recognizes when a phone's signal is of a strength that indicates that the phone is entering the concert hall. It is not necessary that the call control be passed exactly upon crossing the building threshold; call control is typically passed somewhere between the street and the performance area. The venue's base station 910 can be calibrated to recognize the difference between the signal strength of a phone outside the building and the phone at, say, the innermost wall of the lobby. Upon recognizing that a phone 916 has entered the hall, the venue's base station 910 communicates to base station 911 and to the base station controller that it will take control of calls to and from the phone 916, and the network's Location Registers are appropriately updated.

FIG. 9 also shows a partial Home Location Register entry for this network. Entries for phones are shown as having International Mobile Subscriber Identification (IMSI) numbers that match the figure number of the phone for clarity of exposition, though they would not be valid IMSI numbers. (International Mobile Equipment Identification—IMEI—-numbers could be used for this purpose with no impact on the efficacy of the present techniques. The phone identification scheme is illustrative only and is not intended as a restriction on the invention. Similarly, the Home Location Register and Visitor Location Registers, shown in part, are merely illustrative; any representation scheme that contained similar information for a cell phone telephony network would apply as well.) The Home Location Register entry for phone 916 (in the physical range of base stations 910 and 911) shows it as being in cell 8; the entry for phone 917 shows it as being in cell 1. The Visitor Location Register for cell 8 contains phone 916 while the Visitor Location Register for cell 1 contains phone 917. This base station communication extends in a straightforward manner to the case when a concert hall 922, and hence base station 912, is on the border between two cells in the cell telephony network. In this instance, base station 912 recognizes when a phone's signal is of a strength that indicates that the phone is entering the concert hall and communicates to base stations 913 and 914 as well as to the base station controller that it will take control of calls to and from the phone. The Home Location Register entry for phone 918 (in the physical range of base stations 912, 913, and 914) shows it as being in cell 9 and the Visitor Location Register for cell 9 contains phone 918.

In the examples of FIG. 8 or 9, the venue can distinguish between different phones and take advantage of information about a particular phone by virtue of being connected to the cell telephony network. In one variation of the examples of FIG. 8 or 9, the remote signal can be selectively sent to particular phones rather than broadcast to every phone in the venue, just as a phone call is sent to a particular phone. The venue can determine, for a phone under its control, the kind of service plan the subscriber is signed up for, and what services are included in the plan.

In another variation of the examples of FIG. 8 or 9, the transmission equipment 810 set up to send the venue-based control commands is similarly used by the concert hall 800 but this equipment 810 is not a fully operational base station. Instead, the equipment 810 is only used to communicate the venue-issued control commands with the phones 830; in this example, the equipment 810 does not communicate with other base stations or the base station controller and the cell phone telephony network's Location Registers are not updated—whatever base station was responsible for calls to phones 830 immediately before they enter the hall 800 remain responsible for calls to those phones 830 while the phones 830 are in the hall 800.

In another example, the cell phones 830 require no modification at all. Again the concert hall 800 installs a base station 810. This base station 810 tracks phones 830 entering and leaving the range of the base station 810 and updates the cell phone telephony network's Location Registers, as described above, to reflect control of phones 830 within the hall 800 by the venue's base station 810. In this example, the venue's base station 810 does not transmit calls to and from the phones 830 located in the concert hall 800. Instead, for an outgoing call, in one example, the venue's base station 810 ignores the outgoing call signal received from the phone 830 under its control. Because the network's Location Register lists the calling phone 830 as in the cell of the concert hall's base station 810 (and hence under its control) no other base station will respond. The call will go untransmitted as if it were out of range of any base station. For an incoming call, the concert hall's base station 810 will not transmit the incoming call to the phone 830, but will instead respond to the caller with an indication that the user of the phone associated with the called number is unavailable. (If the subscriber using the phone 830 has a voicemail service, the caller could be offered the option of leaving a message in such voicemail.)

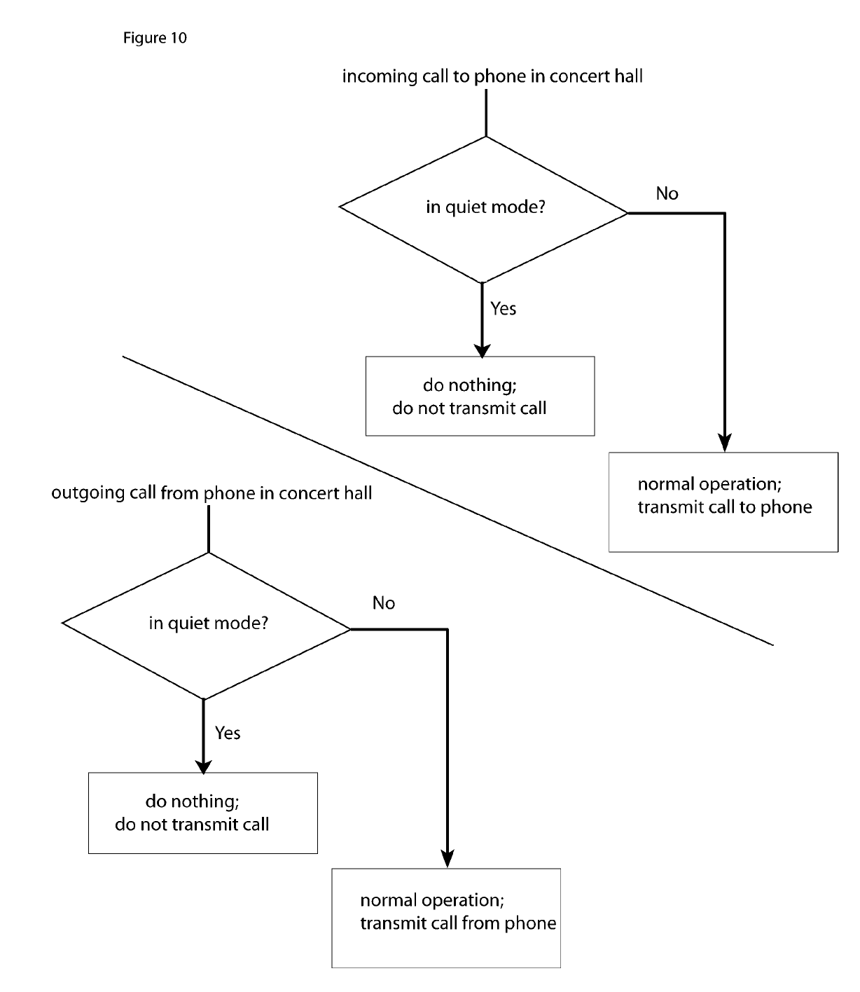

FIG. 10 shows a logic flow diagram for the new logic used for one example of the present techniques. In this example, for an incoming call to a phone in a concert hall, if the venue is in a “quiet mode” (e.g., a performance is underway), then, in one example, the incoming call is not transmitted to the phone in the concert hall. Otherwise, if the venue is not in the quiet mode, then the call is transmitted to the phone in the concert hall. For an outgoing call from a phone in the concert hall, if the venue is in the quiet mode, then, in one example, the outgoing call is not transmitted from the phone in the concert hall. Otherwise, if the venue is not in the quiet mode, then the call is transmitted from the phone in the concert hall.

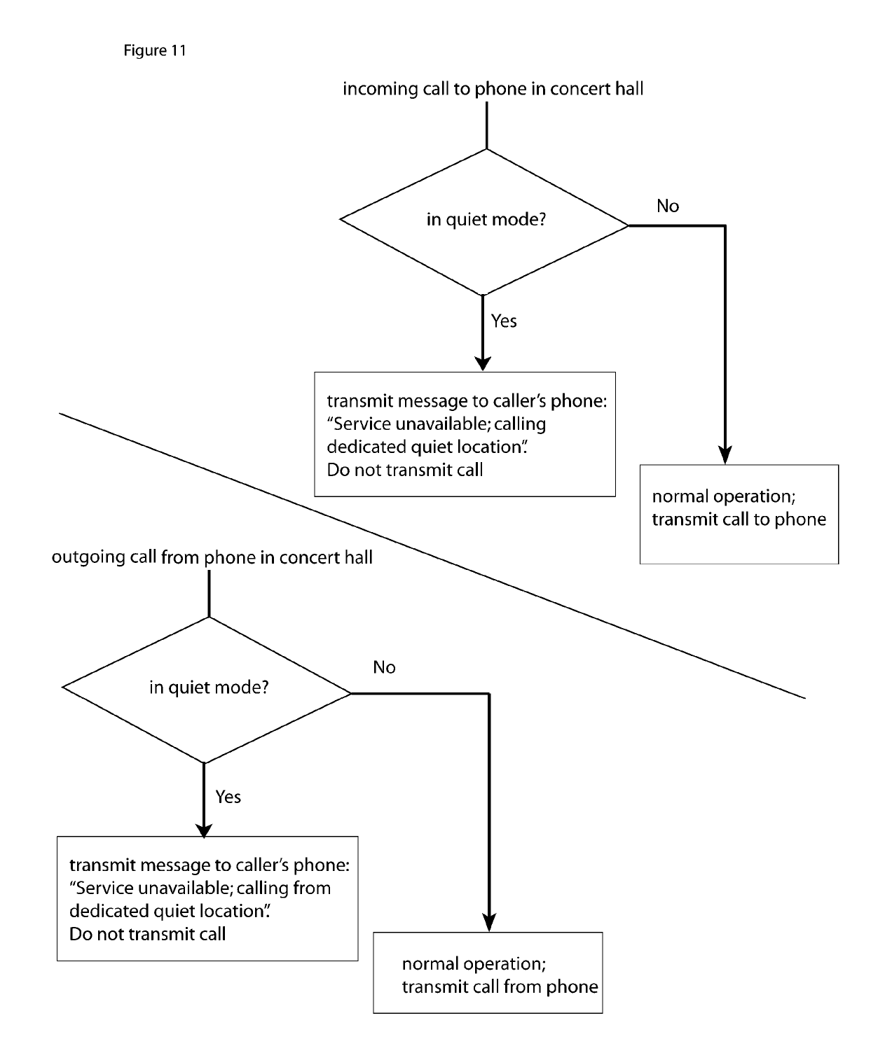

FIG. 11 shows a logic flow diagram for the new logic used for another example of the present techniques. In this example, for an incoming call to a phone in a concert hall, if the venue is in a “quiet mode” (e.g., a performance is underway), then, in one example, the incoming call is not transmitted to the phone in the concert hall. Instead, a message is transmitted to the caller's phone (e.g., “Service unavailable; You are calling to a dedicated quiet location). Otherwise, if the venue is not in the quiet mode, then the call is transmitted to the phone in the concert hall. For an outgoing call from a phone in the concert hall, if the venue is in the quiet mode, then, in one example, the outgoing call is not transmitted from the phone in the concert hall. Instead, a message is transmitted to the caller's phone (e.g., “Service unavailable; You are calling from a dedicated quiet location). Otherwise, if the venue is not in the quiet mode, then the call is transmitted from the phone in the concert hall. This example uses changes to the control commands recognized by the phone and changes to the phone's software so that upon receiving this signal it can put an appropriate message on the phone's screen.

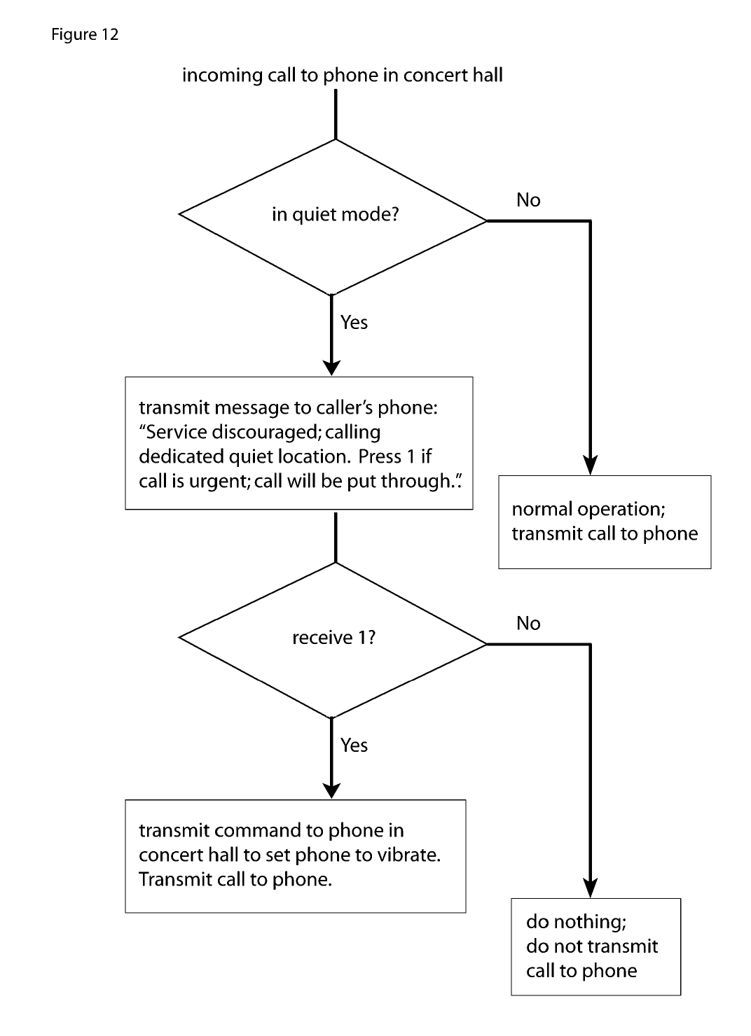

FIG. 12 shows a logic flow diagram for the new logic used for one example of the present techniques. In this example, for an incoming call to a phone in a concert hall, if the venue is in a “quiet mode” (e.g., a performance is underway), then, in one example, a message is transmitted to the caller's phone (e.g., “Service discouraged; You are calling to a dedicated quiet location; Press “1” if the call is urgent, and the call will be put through). If the caller selects the “urgent” option (e.g., by pressing “1” on the calling phone), the base station 810 first transmits a control command to phone 830 ensure that it is switched to a vibrate mode, then the base station 810 transmits the call to the phone within the concert hall 800. If the caller does not select the urgent option, the call is not transmitted to the phone located within the concert hall. Otherwise, if the venue is not in the quiet mode, then the call is transmitted to the phone in the concert hall.

Similarly, for an outgoing call from a phone in the concert hall, in one example, if the venue is in the quiet mode, then, in one example, the outgoing call is not transmitted from the phone in the concert hall. Instead, a message is transmitted to the caller's phone (e.g., “Service discouraged; You are calling from a dedicated quiet location; Press “1” if the call is urgent and the call will be put through). Otherwise, if the venue is not in the quiet mode, then the call is transmitted from the phone in the concert hall. This example uses changes to the control commands recognized by the phone and changes to the phone's software so that upon receiving this signal it can put an appropriate message on the phone's screen. If the caller from within the concert hall selects the “urgent” option (e.g., by pressing “1” on the calling phone), then the base station 810 transmits the call from the phone within the concert hall 800. If the caller within the concert hall does not select the urgent option, the call is not transmitted from the phone located within the concert hall.

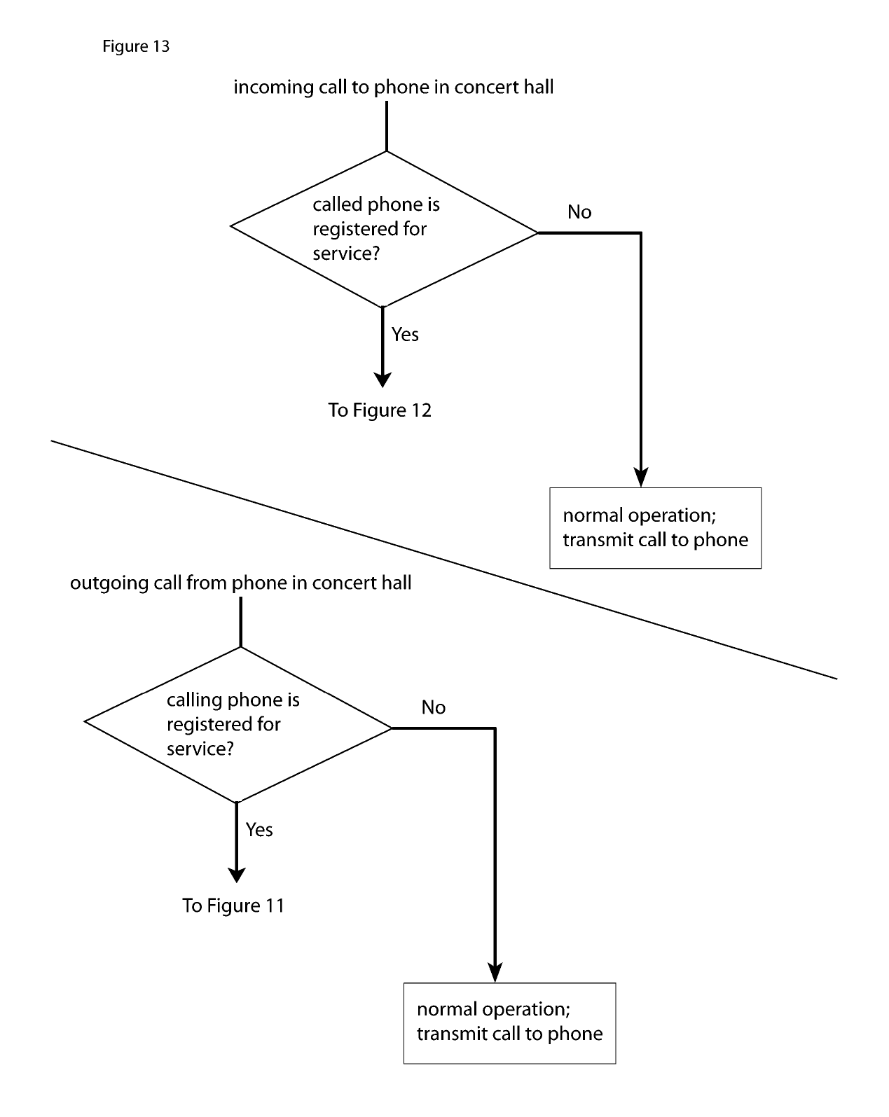

FIG. 13 shows a logic flow diagram for the new logic used for one example of the present techniques; this example can be regarded as both venue-controlled and provider-controlled. For the examples in which the concert hall installs a base station, a service provider (such as AT&T, Verizon, Cingular, MCI, or Sprint) can offer the ability to keep their customers' phones from ringing during performances. A service provider could charge a premium for this additional service, as well as charging the concert hall venue for the base station installation. The service provider would include additional logic in the venue's base station to determine whether a calling or called phone is registered for this service. In one example the mobile communication device includes a memory location to store information indicating whether the mobile communication device is registered for the service. In this example, a controller in the mobile communication device checks the memory location to determine whether the mobile communication device is registered for the service as a precondition to automatically disabling the audible alert. In another example a controller in the base station checks the service plan for the mobile communication device to determine whether it is registered for the service as a precondition to automatically disabling the audible alert.

In the example of FIG. 13, when an incoming call to a phone in a concert hall is detected by the venue's base station, then, in one example, it is determined whether the called phone is registered for the call or ring suppression service. If the called phone is so registered, then process flow continues such as shown in FIG. 12, otherwise the call is transmitted to the phone in the concert hall. When an outgoing call is made from a phone in a concert hall, then, in one example, it is determined whether the calling phone is registered for the call suppression service. If the calling phone is so registered, then process flow continues such as shown in FIG. 11.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A machine-assisted method comprising:
communicating a signal between a remote device and at least one mobile communication device when the mobile communication device is located in association with a venue hosting an occasion when audible usage of the mobile communication device is undesirable; and
automatically disabling an audible alert of the mobile communication device in response to the signal.

2. The method of claim 1, in which at least one of:
the communicating the signal comprises sending a venue-controlled signal from the remote device to the mobile communication device;
the disabling the audible alert includes turning off the mobile communication device in response to the signal;
the disabling the audible alert includes switching the mobile communication device from an audible alert mode to a substantially inaudible alert mode in response to the signal; and
the switching the mobile communication device from an audible alert mode to a substantially inaudible alert mode in response to the signal includes switching, in response to the signal, the mobile communication device from an audible ring mode to a substantially inaudible vibration mode of responding to an incoming call.

3. The method of claim 1, in which the disabling includes disabling an audible alert of all mobile communication devices located in association with the venue in response to the signal.

4. The method of claim 1, in which:
the disabling includes first checking whether a particular mobile communication device is registered for a disabling service before performing the disabling.

5. The method of claim 1, in which at least one of:
the communicating a signal between a remote device and at least one mobile communication device comprises communicating the signal with a remote device located in association with an entry of the venue;
the communicating a signal between a remote device and at least one mobile communication device comprises communicating the signal with a remote device capable of broadcasting the signal over an entire desired area of the venue; and
the communicating a signal between a remote device and at least one mobile communication device comprises communicating the signal with a set of remote devices that, together, are capable of broadcasting the signal over an entire desired area of the venue, and which are capable of avoiding broadcasting the signal outside the desired area of the venue.

6. The method of claim 1, in which the communicating a signal between a remote device and at least one mobile communication device includes communicating a signal between a radio frequency (RF) remote device and the at least one mobile communication device.

7. The method of claim 6, in which the communicating a signal between a remote device and at least one mobile communication device includes communicating a signal between the RF remote device and a first RF receiver at the mobile communication device, wherein the first RF receiver at the mobile communication device is separate from a second RF receiver at the mobile communication device that is used to communicate audio information to the mobile communication device.

8. The method of claim 6, in which the communicating a signal between a remote device and at least one mobile communication device includes communicating a signal between the RF remote device and an RF receiver at the mobile communication device that is also used to communicate audio information to the mobile communication device.

9. The method of claim 1, in which the communicating a signal between a remote device and at least one mobile communication device includes communicating a signal between a cell phone telephony base station as the remote device and the at least one mobile communication device.

10. The method of claim 1, in which the communicating a signal between a remote device and at least one mobile communication device includes using at least one of infrared communication, sonic communication, chemical communication, electromagnetic communication, and magnetic communication.

11. The method of claim 1, comprising:
saving information about a state of at least one switch of the mobile communication device before the disabling the audible alert;
modifying the state of the at least one switch in conjunction with the disabling the audible alert; and
restoring the state of the at least one switch of the mobile communication device after the disabling the audible alert.

12. The method of claim 11, in which the restoring the state of the at least one switch of the mobile communication device is carried out in response to communicating a second signal between the remote device and the mobile communication device.

13. The method of claim 11, in which the communicating a signal between a remote device and at least one mobile communication device includes communicating information about a time at which the restoring the state of the at least one switch is to be carried out.

14. The method of claim 1, in which the communicating the signal between the remote device and at least one mobile communication device includes registering the mobile communication device to a base station associated with the venue, and in which the automatically disabling the audible alert of the mobile communication device includes using the base station to intercept a call to or from the mobile communication device in response to the registering the mobile communication device to the base station associated with the venue.

15. The method of claim 1, in which the automatically disabling an audible alert of the mobile communication device comprises inhibiting a call to the mobile communication device.

16. A system comprising:
a mobile communication device, including:
a speaker to provide an audible alert; and
a communication transceiver to communicate a signal with a remote device to automatically disable the audible alert in response to the signal.

17. The system of claim 16, including a switch to disable the audible alert, in which the switch controls at least one of a power-on status and a ring/vibrate status of the mobile communication device.

18. The system of claim 16, in which at least one of:
the mobile communication device includes a memory location to store information indicating whether the mobile communication device is registered for a service to automatically disable the audible alert, and in which the mobile communication device includes a controller that checks the memory location to determine whether the mobile communication device is registered for the service as a precondition of the automatically disabling the audible alert; and
the mobile communication device includes at least one memory location to save information about a state of at least one switch of the mobile communication device before the disabling the audible alert, and wherein the mobile communication device includes a controller that restores the state of at least one switch of the mobile communication device using the saved information about the state of the at least one switch of the mobile communication device.

19. The system of claim 16, further comprising the remote device.

20. The system of claim 19, in which the remote device comprises an RF transmitter providing the signal to automatically disable the audible alert of the mobile communication device.

21. The system of claim 19, in which the remote device comprises a telephony base station associated with a venue, the telephony base station providing the signal to automatically disable the audible alert of the mobile communication device.

22. A system comprising:
a remote communication device, for location at a venue hosting an occasion when audible usage of a mobile communication device is undesirable, the remote communication device permitting communication of a signal with at least one mobile communication device at the venue to automatically disable an audible alert of the mobile communication device.

23. The system of claim 22, in which the remote communication device includes a telephony base station for the venue to intercept calls to or from all mobile communication devices located at a designated area of the venue to disable the audible alert of the mobile communication devices.
